(19) United States
(12) Patent Application Publication
(10) Pub. No.: US 2025/0286436 A1
(43) Pub. Date: Sep. 11, 2025

(54) ELECTRIC GENERATING ASSEMBLIES

(71) Applicants: David M. Byler, Blanchard, MI (US); David L. McLellan, Remus, MI (US)

(72) Inventors: David M. Byler, Blanchard, MI (US); David L. McLellan, Remus, MI (US)

(21) Appl. No.: 18/595,815

(22) Filed: Mar. 5, 2024

(51) Int. Cl. H02K 7/18; F03D 1/04; F03D 9/25; H02J 7/14

(52) U.S. Cl. CPC H02K 7/183; F03D 1/046; F03D 9/25; H02J 7/14; F05B 2220/706

(57) ABSTRACT

Electric generating assemblies wherein such assemblies are intended to be mounted on a vehicle, such that a front of a hollow funnel is directed to the front of the vehicle. As the vehicle moves forward, the funnel picks up wind which is passed through the funnel and turns a fan which generates electricity.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

Around the turn of the last century and up until the 1970's electrical generation using wind was practiced. The devices utilized then were often windmill type of devices and were intended to capture the wind to supply small amounts of electrical power.

With the advent of electrically powered automobiles and the like, it has become advantageous to utilize large arrays of batteries to supply electrical energy for them.

The instant invention is an attempt to move away from the problems associated with large arrays of batteries and their problems such as fires, extra heavy weight loads on the vehicles, short term driving distances, failure to charge when cold, and the like.

In a search carried out by the patentees herein, there was discovered one piece of prior art pertaining to vehicle-wind generated electrical energy, namely, U.S. Pat. No. 9,643,729 that issued May 9, 2017, to Walter-Robinson, that deals with an energy cell regenerative system for electrically powered aircraft in which the wind force generated by the propeller of an aircraft is used to drive an energy system.

### BRIEF SUMMARY OF THE INVENTION

This invention in one embodiment deals with an electric generating assembly. The assembly comprises an air collection funnel, wherein the funnel has a front end opening and a back end opening. The front end opening is larger in size than the back end opening.

There is a fan, the fan having vertical vanes. The fan is mounted in a predetermined position in the funnel such that a portion of any air moving through the funnel contacts the vanes.

The fan is mounted on a shaft and the shaft extends below said funnel a predetermined distance. The shaft has a terminal end and there is an alternator mounted on the terminal end. The alternator is electrically attached to a voltage regulator by electrical wires.

In a second embodiment, there is an electric generating assembly comprising an air collection funnel. The funnel has a front end opening and a back end opening. The front end opening is larger in size than the back end opening.

There is a fan. The fan has vertical vanes. The fan is mounted in a predetermined position in the funnel such that a portion of any air moving through the funnel contacts the vanes.

The fan is mounted on a first shaft and the first shaft extends below the funnel a predetermined distance. The first shaft has a terminal end and a first pulley mounted on the terminal end.

There is an alternator mounted securely separately from the first shaft. The alternator has an extended center shaft, and the extended center shaft has a second pulley mounted on a terminal end and the first pulley and the second pulley are horizontally aligned. There is a drive belt connecting the first pulley and the second pulley.

There is a voltage regulator electrically attached to the alternator by electrical wires.

### BRIEF DESCRIPTION OF THE SEVERAL VIEWS OF THE DRAWING(S)

FIG. 1 is a full side view of the first embodiment of this invention.

FIG. 2 is a full top view of the device of FIG. 1.

FIG. 3 is a full side view of a second embodiment of this invention.

FIG. 4 is a full side view of the device of FIG. 3 with a battery attached.

### DETAILED DESCRIPTION OF THE INVENTION

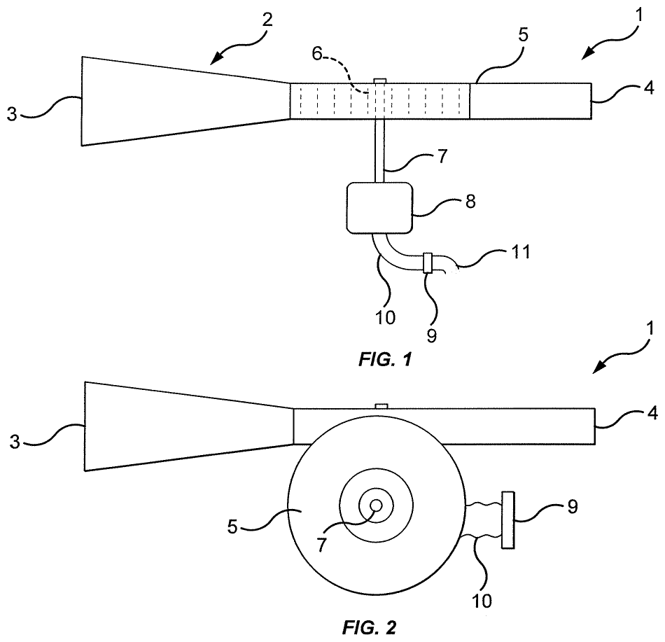

What is disclosed and claimed herein are electric generating assemblies. FIG. 1 shows a full side view of one embodiment of an electric generating assembly 1 of this invention.

Such assemblies are intended to be mounted on a vehicle, such that the front of a hollow funnel is directed to the front of the vehicle. As the vehicle moves forward, the funnel picks up wind which is passed through the funnel and turns a fan which generates electricity.

Thus, in FIG. 1, there is shown an elongated hollow funnel 2, that has a front end 3 and a back end 4 wherein the front end 3 opening is larger in area than the back end 4 opening. This configuration allows air to move through the funnel and as the wind arrives at a narrower part of the funnel 2, the pressure increases. It is at this point and all the way to the back end, that one can insert a fan 5. The fan 5 is included in the funnel 2 as is shown in FIG. 2 or it can be located in only a portion of the funnel 2 (FIG. 2). The configuration of the funnel 2 is not essential, it can be round, elongated either horizontally or vertically, square, triangular, and the like, without affecting the purpose of the invention.

The funnel 2 is mounted such that it is essentially horizontal. The funnel 2 has vertical vanes 6 which catch the wind as it passes through the funnel 2. The funnel 2 can have a length of 1 foot to 6 feet.

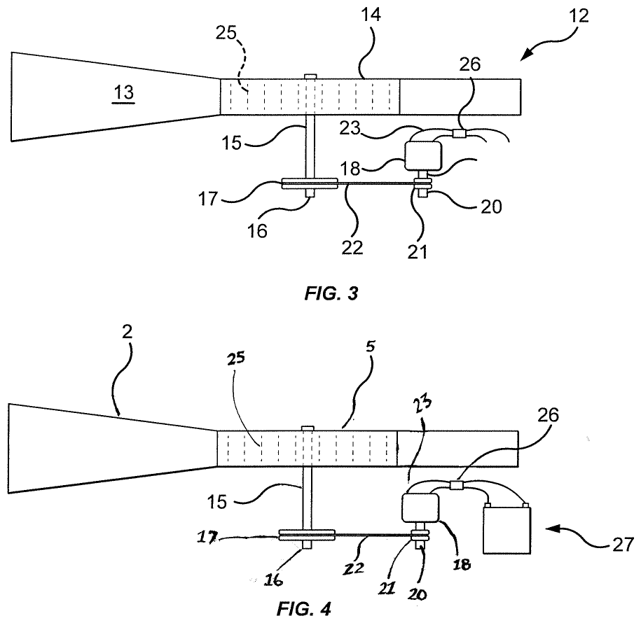

The fan 5 has a center shaft 7 which extends below the actual fan 5 to accommodate and hold an alternator 8. The alternator is electrically attached to a voltage regulator 9 by electrical wires 10. Ultimately, the electrical wires 11 are attached to a battery (FIG. 3). The battery is not part of this device.

As the vehicle moves forward, the wind passes through the funnel 2 driving the fan 5, which drives the shaft 7 which drives the alternator 8 to generate electricity. The voltage regulator 9 governs the amount of voltage fed to the battery. It is estimated that this assembly will generate approximately 14 to 18 volts of electricity if the vehicle is going 50 miles/hour.

FIG. 2 is a full top view of the device of FIG. 1, showing only a portion of the fan 5 inserted in the funnel 2.

Turing now to another embodiment of the invention, there is shown in FIG. 3 an electric generator assembly 12. This assembly 12 comprises a funnel 13, a fan 14 with vertical vanes 25, with a vertical shaft 15 centered in the fan 14. The vertical shaft 15 extends below the fan 14 and it has a terminus end 16. The terminus 16 has a first pulley 17 mounted on it.

There is an alternator 18 that is mounted near the funnel 13 such that it is rigidly mounted. The alternator 18 has a center shaft 19 and this shaft 19 has a terminal end 20. There is a second pulley 21 mounted on the terminal end 20 and this pulley 21 is horizontally aligned with pulley 17. There is a drive belt 22 mounted on the two pulleys. There are first lead wires 23 leading from the alternator 18 to a voltage regulator 26. The voltage regulator 26 has second lead wires leading to a battery. (see FIG. 4).

This embodiment of the invention operates similarly to the embodiment set forth just above.

1. An electric generating assembly, said assembly comprising:
A) an air collection funnel, said funnel having a front-end opening and a back end opening, said front end opening being larger in size than said back end opening;
B) a fan, said fan having vertical vanes, said fan mounted in a predetermined position in said funnel such that a portion of any air moving through the funnel contacts said vanes;
C) said fan being mounted on a shaft and said shaft extending below said funnel a predetermined distance, said shaft having a terminal end;
D) an alternator mounted on said terminal end;
E) said alternator being electrically attached to a voltage regulator by electrical wires.

2. The electric generating assembly as claimed in claim 1 wherein said voltage regulator is attached to a battery by electrical wires.

3. The electric generating assembly, said assembly comprising:
A) an air collection funnel, said funnel having a front-end opening and a back end opening, said front end opening being larger in size than said back end opening;
B) a fan, said fan having vertical vanes, said fan mounted near a middle of said funnel such that a portion of any air moving through the funnel contacts said vanes;
C) said fan being mounted on a first shaft and said first shaft extending below said funnel a predetermined distance, said first shaft having a terminal end and a first pulley mounted on said terminal end;
D) an alternator mounted separately from said first shaft said alternator having an extended center shaft and said extended center shaft having a second pulley mounted on a terminal end thereof and said first pulley and said second pulley horizontally aligned;
E) a drive belt connecting said first pulley and said second pulley;
F) a voltage regulator electrically attached to said alternator by electrical wires.

4. The electric generating assembly as claimed in claim 3 wherein said voltage regulator is electrically attached to a battery by electrical wires.

5. The electric generating assembly as claimed in claim 1 when mounted in a vehicle.

6. The electric generating assembly as claimed in claim 3 when mounted in a vehicle.

7. A method of generating electrical power, said method comprising mounting an electric generating assembly as claimed in claim 1 in a vehicle in a position wherein air is provided to said electric generating assembly.

8. A method of generating electrical power, said method comprising mounting an electric generating assembly as claimed in claim 3 in a vehicle in a position wherein air is provided to said electric generating assembly.
